(19) United States
(12) Patent Application Publication
(10) Pub. No.: US 2006/0046240 A1
(43) Pub. Date: Mar. 2, 2006

(54) Story book and play set

(75) Inventor: Hon Wah Fung, Nam Tin-Kowloon (HK)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Annoboli Pacific Ltd., Hong Kong (CN)

(21) Appl. No.: 10/929,532

(22) Filed: Aug. 30, 2004

(51) Int. Cl. G09B 25/00

(52) U.S. Cl. 434/365

(57) ABSTRACT

A children's book includes a plurality of pages that display text and graphics for collectively representing and conveying to a child a story or theme of the book. The book includes a pivotable center section that provides a play stage having a stage base and a stage background that can be supported in an upright position relative to the stage base with a support. The book includes a plurality of play pieces that are related to the story or theme of the book and are sized, shaped, and configured to provide play action with the play stage and the visual contents of the pages. The play pieces may be attachable to each page, the stage base, and the stage background. The book may also include a plurality of stands to support the play pieces in an upright position relative to the pages and the play stage.

### FIELD OF THE DISCLOSURE

The present application generally relates to children's story books, and more particularly, to a story book and play set.

### BACKGROUND OF THE DISCLOSURE

Children's books typically provide a short story by including text and graphics on a small number of pages. Most young children cannot read, and a few who can read at a very young age do not have the reading skills or patience to read a large amount of text. Thus, children's books typically convey a story to a child by substantially displaying various images of the characters in the story on each page. Accordingly, a child can read or view the pages of a book in a short period of time, which may be as short as a few minutes. With such short reading, however, children often creatively use their imagination to provide their own version of a story or to create their own storyline based on the images shown on each page. Parents can also contribute to the reading process by helping the child imagine various storylines in the book. In any event, because children can quickly loose interest in a book after repeated readings, parents may need to continuously supply their children with new books to encourage reading.

Various children's books have been made that provide additional features to extend a child's interest in a book. For example, some books include various objects installed on each page for a child to touch or manipulate. Such objects may include projections that represent various story characters, textured surfaces such as animal fur, and/or moveable portions of one or more of the printed story characters. As with traditional children's books, however, these books also have a short life span, because as the child repeatedly views each page, the child will become familiar with the manipulative objects and will eventually loose interest in the book. In yet another example, other books have been made that include various sound generating capabilities that add sound effects to the story of the book. Such books typically require batteries, are more expensive than traditional books, are limited in the number of sounds they can generate, and/or may not be rugged enough and break after a few uses.

Therefore, there is a need for a book that substantially functions similar to a traditional book, includes additional play features that are not found in traditional books, and includes features that extend the useful life of the book by repeatedly stimulating a child's imagination.

### SUMMARY

In accordance with one aspect of the disclosure, a book includes a plurality of pages, a plurality of play pieces, a support attached to at least one page to support the at least one page in an upright position relative to a page adjacent to the at least one page. The book also includes a plurality of display stands, and each play piece is uprightly supportable with a display stand.

In accordance with another aspect of the disclosure, a book includes a plurality of pages including a pair of center pages that are uprightly pivotable relative to the plurality of pages. The book includes a binding configured to pivotally couple each page to an adjacent page and pivotally couple the pair center pages to a pair of pages adjacent to the center pages. The book further includes a support attached to the pair of center pages to support the pair of center pages in an upright or vertical position relative to the pair of pages adjacent to the center pages.

In accordance with yet another aspect of the disclosure, a book includes a plurality of pages including displays related to a theme of the book. A binding pivotally couples each page of the book to an adjacent page of the book. The book further includes a plurality of play display stands and a plurality of play pieces shaped as objects or characters forming part of the theme of the book. Each play piece is uprightly supportable on each of the plurality of pages when mounted with any one of the display stands.

These and other aspects and features of the disclosure will be more readily understood upon reading the following detailed description when taken in conjunction with the accompanying drawings.

### BRIEF DESCRIPTION OF THE DRAWINGS

FIG. 1 is a perspective view of a book constructed in accordance with the teachings of the present disclosure.

FIG. 2 is the book of FIG. 1 shown in an open position.

FIG. 3 is the book of FIG. 1 shown in an alternate open position.

FIG. 4 is the book of FIG. 1 shown in yet another alternate open position of FIG. 3.

FIG. 5 is a top view of four exemplary play pieces for use with the book of FIG. 1.

FIG. 6 is a perspective view of the book of FIG. 1, showing an assembled display stand supporting a play piece constructed in accordance with the teachings of the present disclosure.

FIG. 7 is a perspective view of a support for supporting two pages of the book of FIG. 1 in an upright position in accordance with the teachings of the present disclosure.

FIG. 8 is a perspective view of the support of FIG. 7 shown in a first exemplary support position supporting two pages of the book of FIG. 1 in an upright position.

FIG. 9 is a perspective view of the support of FIG. 7 shown in a second exemplary support position supporting two pages of the book of FIG. 1 in an upright position.

FIG. 10 is a top view of a first exemplary display stand for supporting a play piece shown in an unassembled configuration.

FIG. 11 is a top view of a second exemplary display stand for supporting a play piece shown in an unassembled configuration.

FIG. 12 is a perspective view of the play piece of FIG. 10 shown in an assembled configuration.

FIG. 13 is a perspective view of the play piece of FIG. 11 shown in an assembled configuration.

FIG. 14 is a perspective view of a third exemplary display stand shown supporting a play piece in an upright position in accordance with the teachings of the present disclosure.

FIG. 15 is a perspective view of a back side of the book of FIG. 1, showing a storage pouch for storing display pieces and display stands of the book of FIG. 1.

FIG. 16 is a top view of a protective case for storing the book of FIG. 1, showing as having a storage pouch for storing display pieces and display stands of the book of FIG. 1.

### DETAILED DESCRIPTION

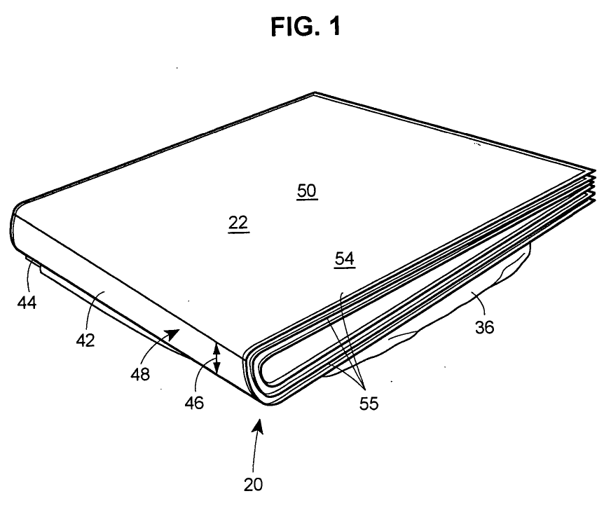

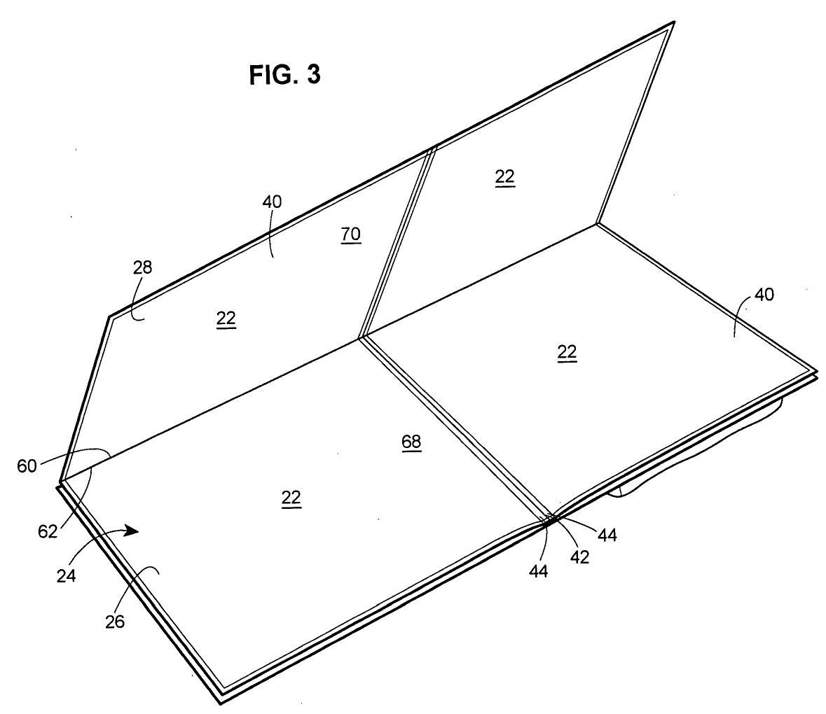

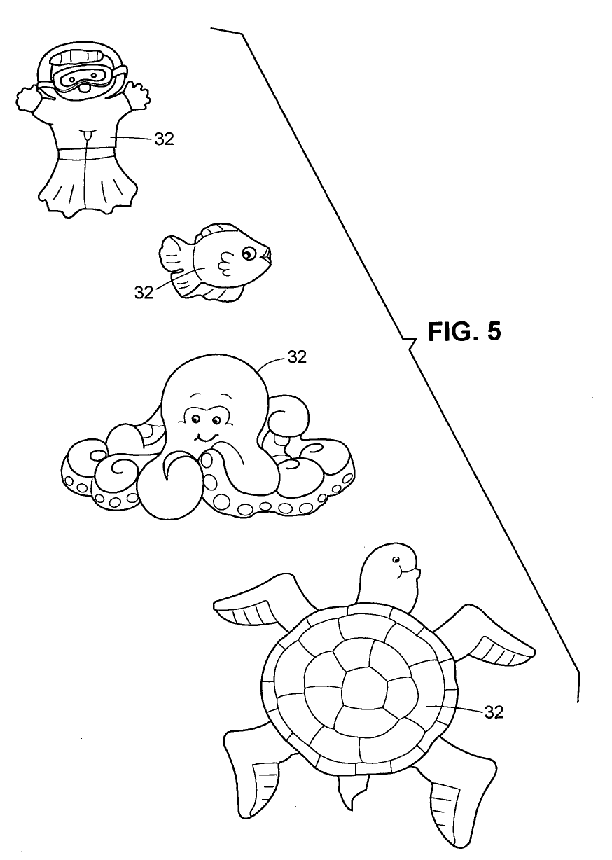

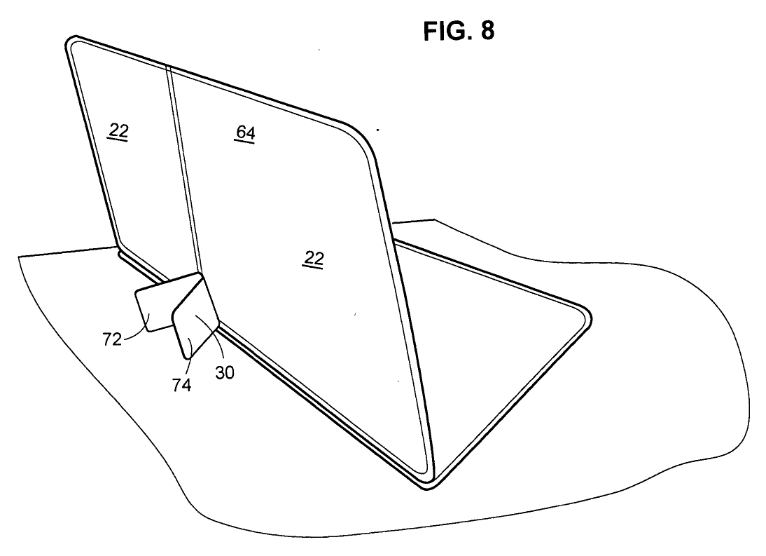

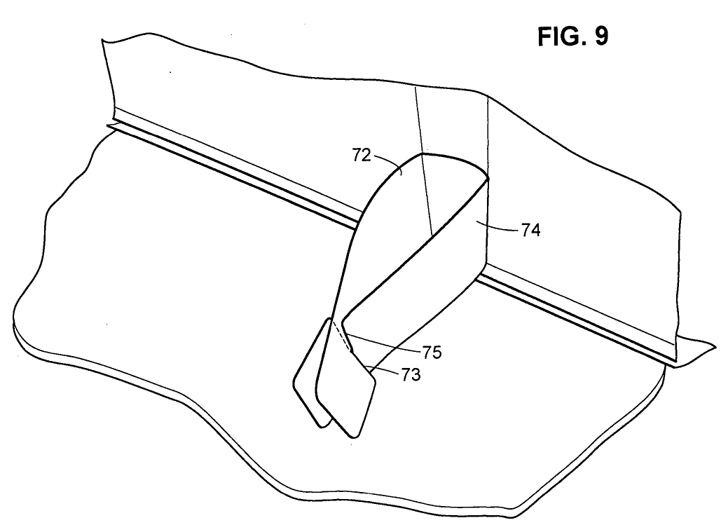

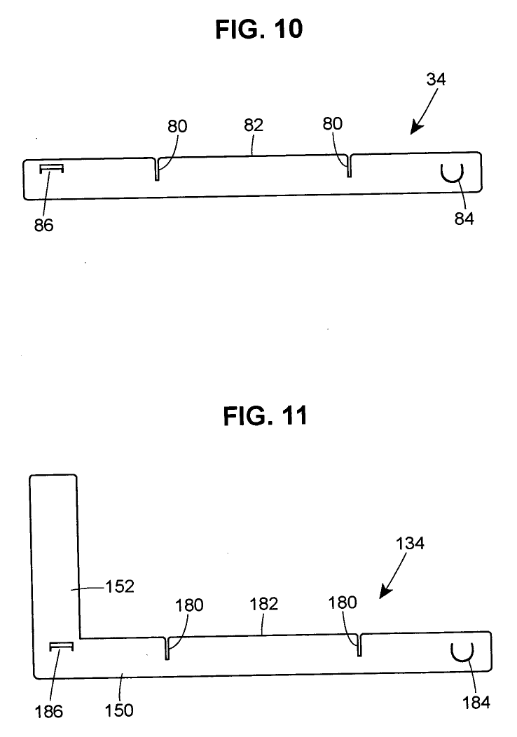

Referring to FIGS. 1-9, a children's play set and book 20 constructed in accordance with the teachings of the present disclosure is generally shown. The book 20 includes a plurality of pages 22 that display text and graphics for collectively representing and conveying to a child a story or theme of the book 20. The book 20 also includes a pivotable center section that provides a play stage 24 (shown in FIGS. 3, 4 and 8). The play stage 24 includes a stage base 26 and a stage background 28 that can be supported in an upright position relative to the stage base 26 with a support 30 (shown in FIGS. 8 and 9). The book 20 includes a plurality of play pieces 32 (shown in FIG. 5) that are related to the story or theme of the book and are sized, shaped, and configured to provide play action with the play stage 24 and the visual contents of the pages 22. The play pieces 32 may be attachable to each page 22, the stage base 26, and the stage background 28. The book 20 may also include a plurality of stands 34,134,234 (shown in FIGS. 10-12). A play piece 32 can be supported in an upright position relative to the pages 22 and the play stage 24 with a stand 34,134, 234 (shown in FIGS. 10-14).

One of ordinary skill in the art will readily appreciate that the book 20 may be constructed in any manner by which typical books are constructed. In other words, the book 20 can be constructed by having a number of individual pages bound together with any type of binding that is known to those of ordinary skill in the art. Additionally, the book 20 can include a number of pages at the center thereof that are connected together and not attached to the binding so as to form the fold-out center section. In the disclosed example, however, and with reference to FIG. 1, the book 20 is constructed from a plurality of stacked oblong panels 40, each of which folds at its center portion 42. The center portion 42 of each panel 40 is laterally bound and defined by two fold regions 44 that are separated by a binding width 46. The binding width 46 is sized to correspond to the thickness of the book 20 when the book 20 is closed. Each panel 40 is divided by the fold regions 44 into two of the pages 22 of the book 20. An outermost panel 40 functions as a front cover 50 and a back cover 52 for the book 20. All or parts of the center portion 42 of each panel 40 are attached to the center portion 42 of an adjacent panel 40 to form a binding 48.

Each panel 40 may be constructed from a rigid or semi-rigid core material (not shown) such as cardboard, heavy weight paper, wood, plastic sheeting, or the like. Accordingly, if each panel 40 is entirely constructed from card board, for example, the fold regions 44 may be scored in each panel 40. In the disclosed example, however, each panel 40 is constructed from a cloth cover 54 that is enclosed to form a casing 55. To provide the pages 22 of each panel 40, two rigid or semi-rigid core panels (not shown) sized to substantially represent the size of each page 22 are housed in the casing 55. Each pair of core panels 22 is positioned in the casing 55 so that the center portion 42 and the fold region 44 of the casing 55 do not include any portions of the two core panels. Accordingly, the center portion 42 and the fold region 44 are constructed entirely of the cloth cover 54 and can easily bend and twist to provide effortless opening and closing of the book 20. To form the binding 48, all or parts of the cloth center portion 42 of each panel 40 may be sewn to all or parts of the cloth center portion 42 of an adjacent panel 40. In the disclosed example, the visual contents of each page 22 are directly printed on the cloth cover 54 that forms the casing 55.

As shown in FIGS. 3, 4 and 8 the play stage 24 is constructed from two pivotally connected panels 40 at the center of the book 20. One of the two pivotally connected panels 40 is the stage base 26 and the other is the stage background 28. The stage base 26 is attached at its center potion 42 to the binding 48 in a manner similar to the other panels 40 of the book 20. In other words, the stage base 26 is bound to the pages beneath it with the binding 48. The stage background 28 is pivotally attached at its lower edge 60 to an upper edge 62 of the stage base 26. Accordingly, the play stage 24 can be unfolded by pivoting the stage background 28 about the stage base 26 between a folded position where the stage background 28 lies on top of the stage base 26 and a plurality of open positions.

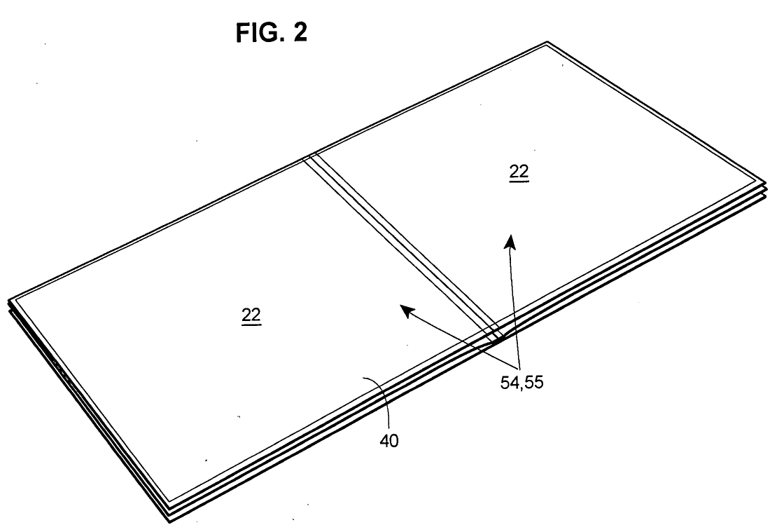

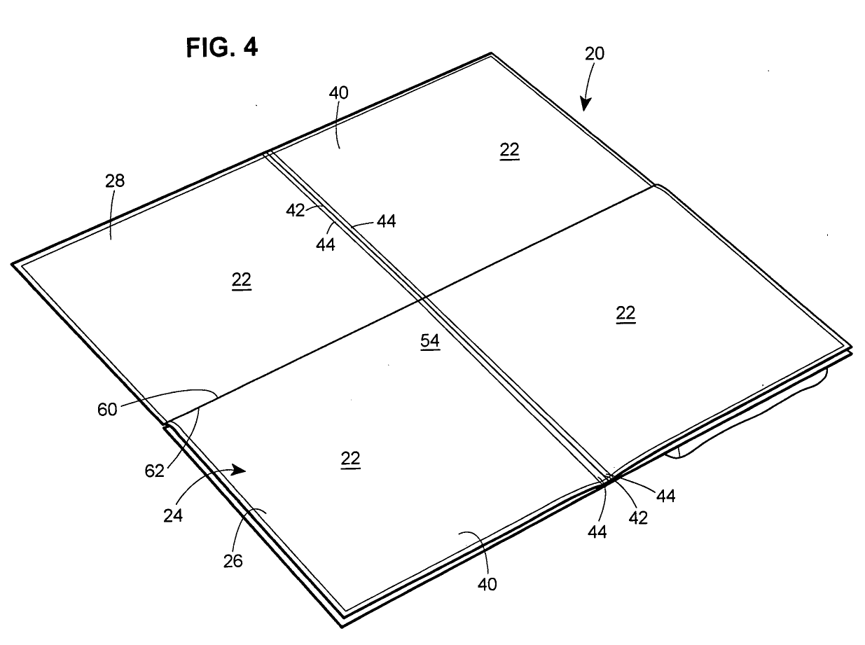

As shown in FIG. 2, when the play stage 24 is folded, the pages 22 of a back side 64 of the stage background 28 can be viewed by a child when flipping the pages 22 from side to side. Thus, when the play stage 24 is folded, a back side 66 of the base stage 26 and the back side 64 of the background stage 28 function as four consecutive pages 22 of the book 20. As shown in FIGS. 3 and 4, when the play stage 24 is unfolded, a front side 68 of the base stage 26 and a front side 70 of the background stage 28 are viewable by a child and are formed by four pages 22 of the book 20. The four pages 22 provide a large contiguous visual play space for a child who is using the book 20. Accordingly, because the four pages 22 of the play stage 24 are connected and provide a contiguous visual play space, the text and/or the visual representations on these pages 22 may also be contiguous.

Although the stage background 28 may be positioned relative to the stage base 26 in numerous ways, a first common position, as shown in FIG. 4, may be a position where the background stage 28 is pivoted relative to the base stage 26 until the background stage 28 is nearly lying in the same plane as the base stage 26, i.e., a rotation of nearly 180° from the folded position. In such a position, the play stage 24 is configured as a substantially horizontal play space consisting of four pages 22. The visual contents of each of the four pages 22 of the play stage 24 can collectively depict a large scene relating to the theme or story of the book 20. A second common position, as shown in FIG. 8, may be a position where the background stage 28 is placed in an upright position relative to the base stage 26. In such a position, the background stage 28 can include visual contents that depict vertically oriented structures, such as buildings, castles, trees, farm houses, or the like. The background stage 28 can also display a sky, clouds, a horizon, and a number of objects depicted in perspective view to convey depth perception to a viewer. Accordingly, when the background stage 28 is in the upright position, a child can feel a sense of realism from the visual contents of the play stage 24 that can make play more enjoyable.

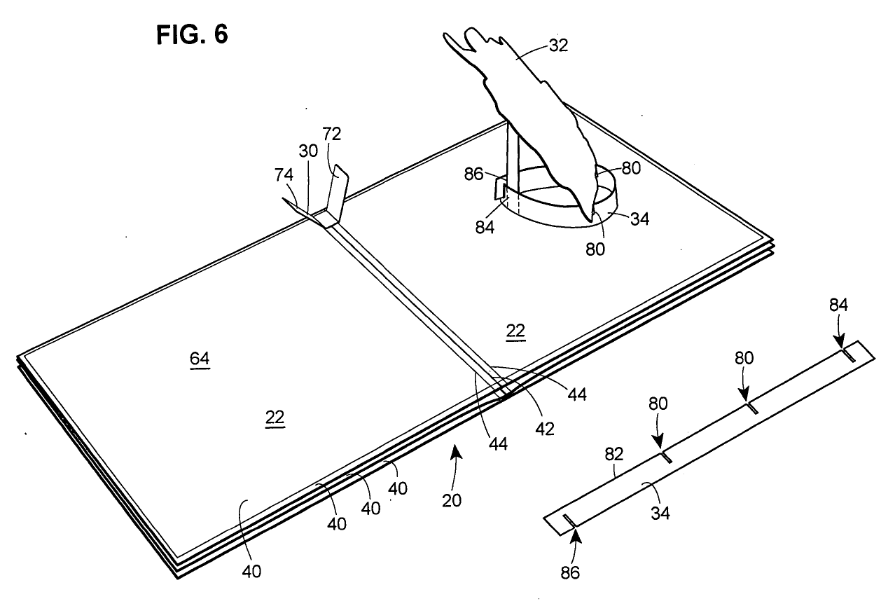

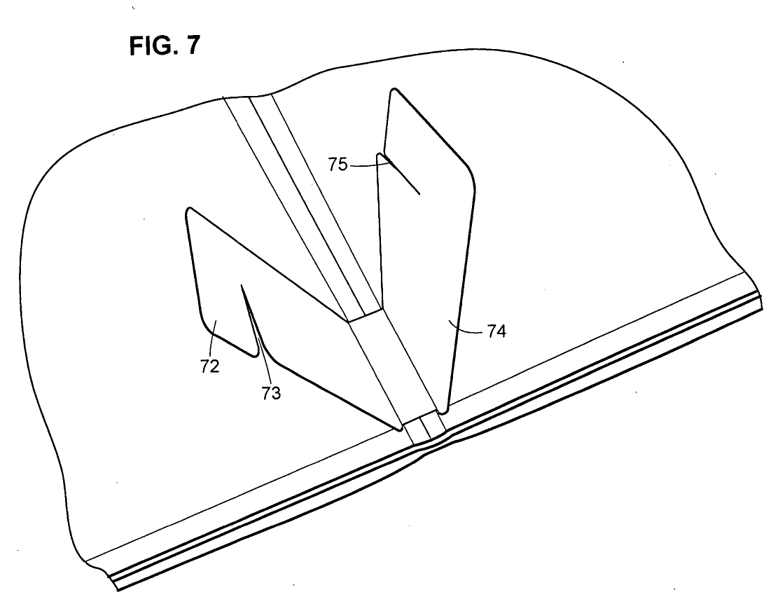

Referring to FIGS. 6-9, to support and maintain the background stage 28 in an upright position, the backside 64 of the background stage 28 includes a support 30. The support 30 includes a first pivotable support arm 72 that can pivot between a position stowed flat on the backside 64 of the background stage 28 and a support position projecting outward from the back side 64 of the background stage 28. The support 30 includes a second pivotable support arm 74 that can pivot between a position stowed substantially flat on the back side 64 of the background stage 28 and a support position projecting outward from the front side 70 of the background stage 28. The support arms 72 and 74 are positioned near the lower edge of the back side 64 of the background stage 28 and are symmetric with respect to the binding 48. In a first disclosed example of the support 30, as shown in FIGS. 7 and 8, the support arms 72 and 74 form a V-shaped support structure similar to an easel when both are pivoted to the support position. In a second disclosed example of the support 30, as shown in FIGS. 7 and 9, the support arm 72 includes a support slit 73 that engages a support slit 75 of the support arm 74. For example, the support slit 73 of the support arm 72 can be inserted in the support slit 75 of the support arm 74 to securely connect the two support arms 72 and 74 together. Thus, in both the first disclosed example and the second disclosed example of the support 30, the support arms 72 and 74 contact a surface on which the book 20 rests to support and maintain the background stage 28 in an upright position. The support arms 72 and 74 may be substantially transparent to reduce interference with the contents of the back side 64 of the background stage 28 when in the stowed position. In the disclosed examples, the support arms 72 and 74 are constructed from a substantially transparent plastic material. Polypropylene is a particularly useful material.

The book 20 can include a number of play pieces 32 that are sized, shaped and configured to relate to the theme or story of the book 20. Four exemplary play pieces are shown in FIG. 5. For example, if the pages 22 of the book 20 depict various parts of a typical farm, the play pieces 32 can be shaped to resemble different farm animals and sized to correspond in size to the contents of the book 20. The play pieces 32 can be placed on the pages 22 of the book 20 to provide a variety of optional visual scenes in combination with the visual contents of the pages 22. To prevent a play piece 32 from moving when placed on a page 22, the play piece 32 may be removably attachable to each page 22. One or ordinary skill in the art will readily appreciate numerous well know methods by which the play pieces 32 can be attached to the pages 22. For example, the core panel of each page 22 can include a magnetic layer, and the back of each play piece 32 can include a magnet. Accordingly, each play piece 32 can remain attached to a page 22 when place thereon. In the disclosed example, however, the cover 54 of the core material of each page 22 is a felt material, and at least the back of each play piece 32 is covered with the felt material. When a play piece 32 is placed on a page 22, the fibers of the felt materials of the page 22 and the back of the play piece 32 engage each other to frictionally maintain the play piece 32 on the page.

As described above, the play pieces 32 can be attached to each page 22 to provide visual interaction between the play pieces 32 and the visual contents of the pages 22. The play pieces 32 can also be attached to the stage base 26 and the stage background 28 when the play stage 24 is unfolded. As shown in FIG. 6, when the play stage 24 is unfolded, a play piece 32 can be supported in an upright orientation with a display stand 34. The book 20 may be provided with a number of stands 34, 134,234 that correspond to the number of play pieces 32. Accordingly, each and every play piece 32 may be supported in an upright orientation with a display stand 34,134,234. Alternately, the book 20 may be provided with a number of stands 34, 134,234 that one more or less in number than the number of the play pieces 32. Since the play pieces 32 may be shaped like human characters, fictional characters, animals, or other children story book characters, the upright orientation of the play pieces 32 can offer more realistic play action. A play piece 32 can be supported with a stand 34,134,234. Additionally, a play piece 32 can be simply picked up with the stand 34,134,234 on which it is supported and moved around on the stage base 26 while in the upright orientation to provide a theatrical play action for the child.

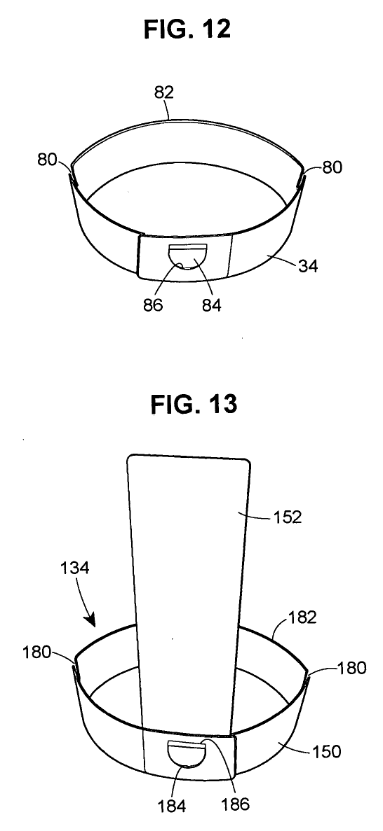

Referring to FIGS. 6 and 10-14, three disclosed examples of a stand 34, 134, and 234, constructed in accordance with the teachings of the present disclosure are generally shown. Referring first to FIGS. 10 and 12, the stand 34 may include a plurality of mounting slits 80 disposed along a longitudinal side 82 thereof. The stand 34 further includes an assembly tab 84 that is positioned near a lateral end thereof and a corresponding assembly slit 86 that is positioned near the opposing lateral end thereof. As shown in FIG. 12, to assemble the stand 34, a user can bend the stand 34 to form a loop such that the assembly tab 84 and the assembly slit 86 are aligned. To secure the stand 34 in the assembled configuration (i.e., the loop), the assembly slit 86 can receive therein the assembly tab 84. Accordingly, the assembly tab 84 engages the assembly slit 86 to secure the stand 34 in the assembled configuration.

When the stand 34 is in the assembled configuration, the mounting slits 80 will be radially distributed along the stand 34 such that one or more pairs of the mounting slits 80 are positioned on opposing sides of the stand 34. In other words, at least a pair of mounting slits 80 can be virtually connected by a straight line passing through the loop that forms the stand 34 in the assembled configuration. To mount a play piece 32 on the stand 34, an edge portion of the play piece 32 can be inserted in a pair of the opposed mounting slits 80. The thickness of the play piece 32 may be nearly similar to the thickness of the mounting slits 80. Accordingly, the mounting slits 80 will hold the play piece 32 in an upright position. Additionally, because the mounting slits 80 are on the opposing sides of the stand 34, the stand 34 prevents the play pieces 32 from any type of free movement including rotation. A play piece 32 can be removed from a stand 34 by simply being pulled out of the mounting slits 80. Each stand 34 may have a different length and include more than two mounting slits 80 so that play pieces 32 of various sizes can be supported by the stands 34.

Referring to FIGS. 6, 11 and 13, the stand 134 is shown. The stand 134 is a generally L-shaped thin strip and constructed from a flexibly resilient material. The stand 134 includes a base portion 150 and an upright support portion 152. The base portion 150 may include a plurality of mounting slits 180 disposed along a longitudinal side 182 thereof. The base portion 150 further includes an assembly tab 184 that is positioned near a lateral end thereof and a corresponding assembly slit 186 that is positioned near the opposing lateral end thereof. As shown in FIG. 13, to assemble the stand 134, a user can bend the base portion 150 to form a loop such that the assembly tab 184 and the assembly slit 186 are aligned. To secure the stand 134 in the assembled configuration (i.e., the loop), the assembly slit 186 can receive therein the assembly tab 184. Accordingly, the assembly tab 184 engages the assembly slit 186 to secure the stand 134 in the assembled configuration. When the stand 134 is assembled, the upright support portion 152 will be positioned substantially perpendicular to the base portion 150. As will become apparent from the following, base portion 150 and the upright support portion 152 cooperatively support a play piece 32 in an upright position.

When the stand 134 is in the assembled configuration, the mounting slits 180 will be radially distributed along the base portion 150 such that one or more pairs of the mounting slits 180 are positioned on opposing sides of the base portion 150. In other words, at least a pair of mounting slits 180 can be virtually connected by a straight line passing through the loop that forms the base portion 150 in the assembled configuration. As shown in FIG. 6, to mount a play piece 32 on the stand 134, an edge portion of the play piece 32 can be inserted in a pair of the opposed mounting slits 180. The thickness of the play piece 32 may be nearly similar to the thickness of the mounting slits 180. Accordingly, the mounting slits 180 will hold the play piece 32 in an upright position. However, the play pieces 32 may have a smaller thickness than the mounting slits 180 so as to not be supportable in an upright position in the mounting slits 180. Additionally, the play pieces 32 may be so flexible so as to bend when placed in the mounting slits 180 and not remain in an upright position. As shown in FIG. 6, to maintain a play piece 32 in an upright position when supported by a stand 134, the play piece 32 can lean on the upright support portion 152. Thus, the upright support portion 152 can cooperatively support a play piece 32 in an upright position with the base portion 150. Each play piece 32 can be removed from a stand 134 by simply being pulled out of the mounting slits 180. Each stand 134 may have a different length and include more than two mounting slits 180 so that play pieces 32 of various sizes can be supported by the stands 134.

The stands 34 and 134 are constructed from a flexible material so that they can be readily and easily converted by a child between the unassembled and assembled configurations. In the disclosed examples, the stands 34 and 134 may be substantially transparent so as to reduce visual interference with the contents of the pages 22 on which they are placed. In the disclosed example, the stands 34 and 134 are constructed from a substantially transparent plastic material that is also resiliently flexible. Polypropylene is a particularly useful material.

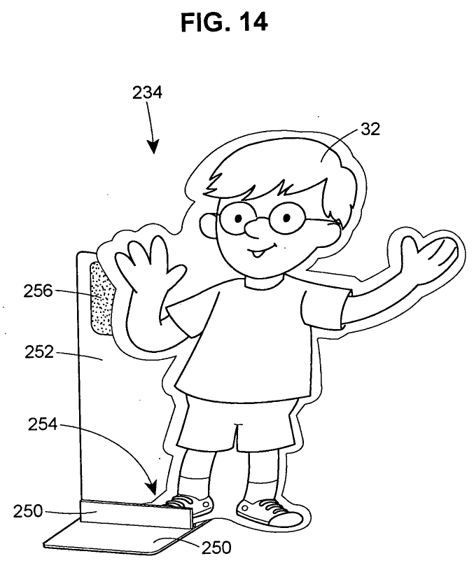

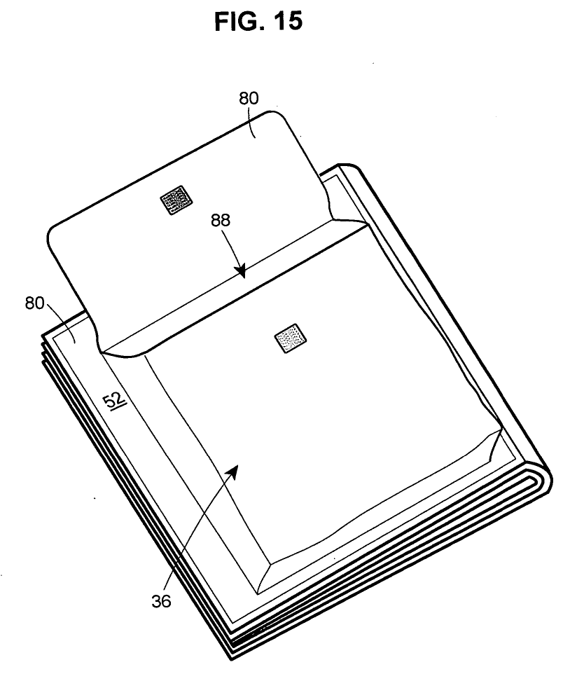

Referring to FIG. 14, the stand 234 is generally shown. The stand 234 includes a base 250 and an upright support 252. The upright support 252 can be inserted in a slot 254 on top of the base 250 and remain in the slot 254 by frictionally engaging the slot 254. Accordingly, when the upright support 252 is inserted in the slot 254, it projects upward from and substantially perpendicular to the base 250. A top portion of the upright support 252 includes a patch of material 256 for engaging and maintaining a play piece 32 in an upright orientation. The patch of material 256 may be constructed from any material that interacts with the material of a play piece 32 to restrict the movement of the play piece 32. For example, if the play piece 32 includes a magnetically capable metallic layer, the patch of material 256 may be a thin magnetic strip to provide attachment of the play piece 32 to the upright support 252. In the disclosed example, as shown in FIG. 14, the patch of material 256 may be constructed from felt or Velcro® to frictionally engage a felt backing of a play piece 32. Additionally, as shown in FIG. 14, a bottom edge of a play piece 32 is inserted in the slot 254 to securely orient the play piece 32 in an upright position with the cooperation of the patch of material 256. Alternately, the stand 234 may be used without the upright support 252. Accordingly, a play piece 32 can be inserted in the slot 254 on top of the base 250. Thus, the base 150 alone can provide support for the play piece 32.

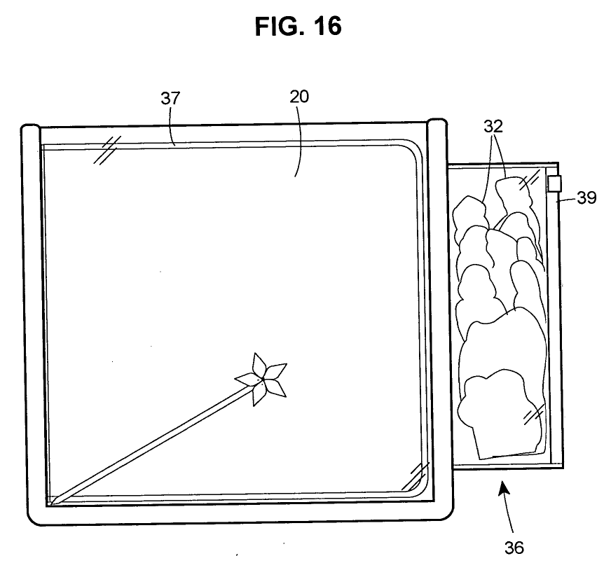

Referring to FIGS. 15 and 16, the book 20 may be provided with a storage pouch 36 for storing the play pieces 32 and stands 34 that are not being used. The storage pouch 36 may be either attached to the book 20, as shown in FIG. 15, or may be part of a protective case 37 (shown in FIG. 16) that is provided with the book 20. Referring to FIG. 15, when the storage pouch is attached to the book 20, it may be attached to the back cover 52 so as to not interfere with the contents of the book 20. The storage pouch 36 may include a closure flap 86 that can close an opening 88 of the pouch 36 to prevent the contents of the pouch 36 from falling out. The closure flap 86 can be attached to the pouch 36 by closure devices that are well known to those of ordinary skill in the art, such as a Velcro® fastener system, buttons, magnetic buttons, or the like. Referring to FIG. 16, the storage pouch 36 is shown as part of the protective case 37 in which the book 20 may be stored or displayed for sale. To open and close the storage pouch 36, a closure device 39 such as a zipper (shown in FIG. 16), Velcro® fastener system, buttons, magnetic buttons or the like, may be provided at an opening of the storage pouch 36. Additionally, the storage pouch 36 may be constructed from a transparent material so that the child can see the contents of the storage pouch 36 without having to open storage pouch 36.

Persons of ordinary skill in the art will appreciate that, although the teachings of the present disclosure have been illustrated in connection with certain embodiments, there is no intent to limit the present disclosure to such embodiments. On the contrary, the intention of this application is to cover all modifications and embodiments fairly falling within the scope of the teachings of the present disclosure.

What is claimed is:

1. A book comprising:
a plurality of pages;
a plurality of play pieces;
a support attached to at least one page to support the at least one page in an upright position relative to a page adjacent to the at least one page; and
a plurality of display stands to mount said play pieces in a vertical position.

2. The book of claim 1, the plurality of pages including a pair of center pages uprightly pivotable relative to the plurality of pages, wherein the pair of center pages define a stage background of a play stage and a pair of adjacent pages define a stage base of the play stage.

3. The book of claim 2, wherein the support is attached to the stage background to support the stage background in an upright position relative to the stage base.

4. The book of claim 3, wherein the support is configured to be pivotable relative to the stage background between a stowed position lying substantially flat against the stage background and a support position projecting outward from the stage background.

5. The book of claim 1, each display stand including a strip being resiliently bendable to form a loop.

6. The book of claim 5, the loop including at least a pair of slits sized to receive any one of the play pieces to support the play piece in an upright position.

7. The book of claim 5, the strip including a base portion and an upright support portion, the upright support portion oriented substantially perpendicular to the base portion.

8. The book of claim 1, each display stand include a base and an upright support, wherein the base includes a slot to removably attach the upright support thereto.

9. The book of claim 1, further comprising a storage pouch attached to one of the pages to store the play pieces and the stands.

10. The book of claim 1, further comprising a protective case having a storage pouch attached thereto to store the play pieces and the stands.

11. The book of claim 1, wherein each of the play pieces is removably attachable to each page of the plurality of pages.

12. The book of claim 1, wherein the plurality of pages include a felt cover and each of the play pieces include a felt backing to be removably attachable to each page of the plurality of the pages.

13. A book comprising:
a plurality of pages including a pair of center pages being uprightly pivotable relative to the plurality of pages;
a binding configured to pivotally couple each page to an adjacent page and pivotally couple the pair center pages to a pair of pages adjacent to the center pages; and
a support attached to the pair of center pages to support the pair of center pages in an upright position relative to the pair of pages adjacent to the center pages.

14. The book of claim 13, wherein the support is configured to be pivotable relative to the center pages between a stowed position lying substantially flat against the center pages and a support position projecting outward from the center pages.

15. The book of claim 13, further comprising a plurality of play pieces shaped to relate to a theme of the plurality of pages.

16. The book of claim 15, further comprising a plurality of display stands, each play piece being uprightly supportable on any one of the display stands.

17. The book of claim 16, the loop including at least a pair of slits sized to receive any one of the play pieces to support the play piece in an upright position.

18. The book of claim 16, each display stand including a base portion and an upright support portion, the upright support portion oriented substantially perpendicular to the base portion.

19. The book of claim 16, each display stand including a base and an upright support, wherein the base includes a slot to removably attach the upright support thereto.

20. The book of claim 16, further comprising a storage pouch attached to one of the pages to store the play pieces and the stands.

21. The book of claim 16, further comprising a protective case having a storage pouch attached thereto to store the play pieces and the stands.

22. The book of claim 16, wherein each of the play pieces is removably attachable to each page of the plurality of pages.

23. The book of claim 16, wherein the plurality of pages include a felt cover and each of the play pieces include a felt backing to be removably attachable to each page of the plurality of the pages.

24. A book comprising:
a plurality of pages including displays related to a theme of the book;
a binding pivotally coupling each page to an adjacent page;
a plurality of play pieces shaped to relate to the theme of the book; and
a plurality of display stands;
wherein each play piece is uprightly supportable on each of the plurality of pages with any one of the display stands.

25. The book of claim 24, the plurality of pages comprising a pair of center pages uprightly pivotable relative to the plurality of pages, wherein the pair of center pages define a stage background of a play stage and a pair of adjacent pages define a stage base of the play stage.

26. The book of claim 25, wherein the support is configured to be pivotable relative to the stage background between a stowed position lying substantially flat against the stage background and a support position projecting outward from the stage background.

27. The book of claim 24, each display stand including a strip being resiliently bendable to form a loop.

28. The book of claim 27, the loop including at least a pair of slits sized to receive any one of the play pieces to support the play piece in an upright position.

29. The book of claim 27, the strip including a base portion and an upright support portion, the upright support portion oriented substantially perpendicular to the base portion.

30. The book of claim 24, each display stand including a base and an upright support, wherein the base includes a slot to removably attach the upright support thereto.

31. The book of claim 24, further comprising a storage pouch attached to one of the pages to store the play pieces and the stands.

32. The book of claim 24, further comprising a protective case having a storage pouch attached thereto to store the play pieces and the stands.

33. The book of claim 24, wherein each of the play pieces is removably attachable to each page of the plurality of pages.

34. The book of claim 24, wherein the plurality of pages include a felt cover and each of the play pieces include a felt backing to be removably attachable to each page of the plurality of the pages.
